(19) United States
(12) Patent Application Publication
(10) Pub. No.: US 2010/0299882 A1
(43) Pub. Date: Dec. 2, 2010

(54) CORD SAFETY DEVICE FOR WINDOW BLIND

(76) Inventor: Denise Brylko, Cumming, GA (US)

Correspondence Address: LAW OFFICE OF JERRY D. HAYNES , P.A, P.O. Box 350392, Fort Lauderdale, FL, 33335, US

(21) Appl. No.: 12/476,344

(22) Filed: Jun. 2, 2009

(51) Int. Cl. F16G 11/10

(52) U.S. Cl. 24/115 F

(57) ABSTRACT

The present invention relates to a cord safety device for a window blind that includes: a housing which includes a first member and a second member, the first member and second member adjoined by a connecting member; an attachment mechanism mounted on the housing, where the attachment mechanism provides a method to attach the device to cords used to adjust the configuration of the window blind; and a cavity between the first member and second member, where the cavity stores the cords when the first member and second member are in a closed position. In one exemplary embodiment, the first member includes a first base portion with a first skirt extending from a periphery of the first base portion and the second member includes a second base portion with a second skirt extending from a periphery of the second base portion.

### BACKGROUND OF THE INVENTION

1. Field of the Invention

The present invention generally relates to window blinds, and more specifically, to a cord safety device for window blinds directed toward infants and small children.

2. Description of Related Art

Human civilization has seen a remarkable change in field of architecture from caves to present day houses and buildings. The need for an architectural structure such as a house or a building has been very much the same as was in the past i.e., for shelter, safety, protection from wind and rain, and the like. Besides structural components such as walls, roof, doors flooring, and the like, windows are also important and integral part of the architectural structure. The window is an opening in a wall of an architectural structure that allows light and possibly air into a room of the architectural structure, and also allows occupants to see outside the architectural structure. In order to maintain privacy of the occupants of the architectural structure, to regulate light and air coming into the room, and to minimize heat transfer, the window is generally covered with a window blind.

The window blind is a covering composed of long strips of fabric or rigid material arranged vertically or horizontally. There are many types of blinds known in the art such as a Venetian blind, plantation blind, mini blind, Holland blind, pleated blind, and the like. Typically, the blind consists of a number of long strips of metal, vinyl, or wood attached in rows or columns. The long strips are known as slats. The slats of the blind are usually connected with cords such that they may be turned to an open position to allow light to pass through them by becoming parallel with a window-sill, or conversely turned flat to a closed position that blocks light from outside the window. Turning of the slats of the blind is usually accomplished by rotating a metal or plastic component such as a pulley provided at an upper corner of the blind. The position of the blind over the window and orientation of the slats is set by pulling or relaxing cords coupled to the slats through pulleys. For convenience in pulling or relaxing the cords, such cords form a continuous loop operable by a tassel. The cords often extend downwardly to a position slightly above floor height or to a position at floor height.

It has been seen that infants and small children are very fascinated with the cords of the blind. However, the infants and the small children are unaware about the risk associated with such cords of the blind. The cords can act as a noose for the infants or the small children, if their head or other body part gets caught between the cords. To safeguard infants and small children from the potential risk associated with the cords, parents employ different devices and methods such as tying, or using a cleat to keep the cords out of the reach of the infants and the small children. However, it has been observed, parents inadvertently forget to tie the cords to shorten the cords and as such infants and small children remain vulnerable to the risks associated with the cords. Further, usage of the cleats involves punching holes into the wall near the window to fix the cleat, which in turn spoils the aesthetic look of the room. As such the conventional devices and methods have failed to address the concerns of the parents.

Accordingly, there persists a need for a cord safety device for a blind which keeps cords of the blind of a window at a safe distance above the reach of infants and small children. Therefore, it is an object of the present invention to obviate the above and other disadvantages from existing art and to provide a cord safety device for a blind for suspension of cords of the blind at a safe distance above the reach of infants and small children. It is further an object of the present invention to provide a cord safety device for a blind of a window, which is user friendly, lightweight, durable, attractive, and having low production cost. It is further an object of the present invention to provide a cord safety device for a blind which enhances aesthetic look of the blind.

### SUMMARY OF THE INVENTION

The present invention relates to a cord safety device for a window blind comprising: a housing which includes a first member and a second member, the first member and second member adjoined by a connecting member; an attachment means mounted on the housing, where the attachment means provides a means to attach the device to cords used to adjust the configuration of the window blind; and a cavity between the first member and second member, where the cavity stores the cords when the first member and second member are in a closed position. In one exemplary embodiment, the first member includes a first base portion with a first skirt extending from a periphery of the first base portion and the second member includes a second base portion with a second skirt extending from a periphery of the second base portion.

### BRIEF DESCRIPTION OF DRAWINGS

FIG. 1 is a view of a cord safety device for a window blind, in accordance with an exemplary embodiment of the present invention; and

FIG. 2 is a view of a cord safety device configured on a window blind, in accordance with an exemplary embodiment of the present invention.

### DETAILED DESCRIPTION

The present invention provides a cord safety device for a window blind that keeps cords of the blind out of reach of infants and small children and at the same time enhances the aesthetic look of the blind. The present invention may be utilized with all types of manually drawn blinds used in homes and commercial places. It is envisioned that the present invention can be easily incorporated into a multitude of window blinds and provides a cord safety device.

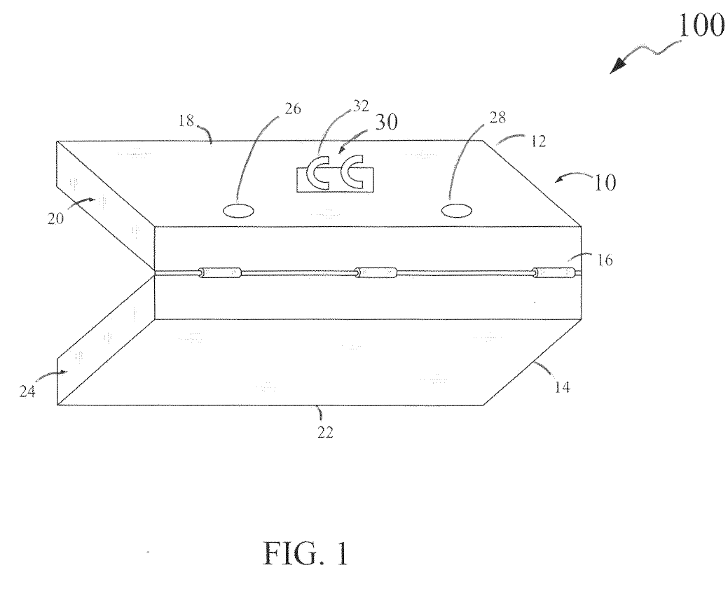

FIG. 1 illustrates a cord safety device 100 for a blind, in accordance with an exemplary embodiment of the present invention. The device 100 includes a housing 10 and an attachment means 30 mounted on the housing 10. The housing 10 includes a first member 12 and a second member 14 hingedly connected to the first member 12 by means of a connecting member 16. The connecting member 16 may be any connecting element known in the art which includes, but is not limited to, a hinge. The first member 12 includes a first base portion 18 with a first skirt 20 extending from a periphery of the first base portion 18. Similarly, the second member 14 includes a second base portion 22 with a second skirt 24 extending from a periphery of the second base portion 22. The first member 12 and the second member are configured to assume a closed position and an open position. In the closed position, the first member 12 and the second member are arranged in a manner such that a the first skirt 20 is in contact with the second skirt 24 to configure a cavity in between the first member 12 and the second member 14.

The housing 10 is configured to hold a tassel (not shown) of the blind within the cavity. The housing 10 may be of any shape such as rectangular, cuboidal, cubic, oval, polygonal, and the like. The first member 12 and the second member 14 may be fabricated from flexible, semi-rigid or rigid materials such as plastic, aluminum, glass and the like. However, it will be apparent to those skilled in the art that appearance, structural configuration and the material comprising the housing 10 as set forth herein is for purposes of illustration and that the present invention is not limited to the appearance, structural configuration or the material comprising the housing 10. Further, the first base portion 18 of the first member 12 may have apertures such as apertures 26, 28 for allowing cords of the blind to pass into the housing 10 in order to accommodate the tassel within the cavity of the housing 10. In an embodiment of the present invention, the tassel may be removed from the cords. Thereafter, the cords may be inserted through the apertures 26, 28 of the housing 10 as such precluding the need of conventional tassels.

The attachment means 30 is mounted on the housing 10. More specifically, the attachment means is attached on an outer side of the first member 12. The attachment means 30 is adapted to keep the cords of the blind at a place above the reach of infants and small children. The attachment means 30 may be a hooked shaped member 32 as shown in FIG. 1. In one exemplary embodiment of the present invention, the attachment member 30 is a clip (not shown) for holding the device 100 at a conspicuous place out of the reach of the infants or the small children. However, it will be apparent to those skilled in the art that appearance and structural configuration of the attachment means 30, as set forth herein is for purposes of illustration and that the present invention is not limited to the appearance and the structural configuration of the attachment means 30.

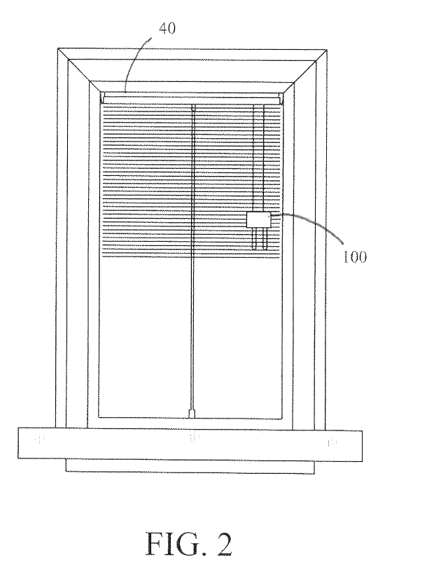

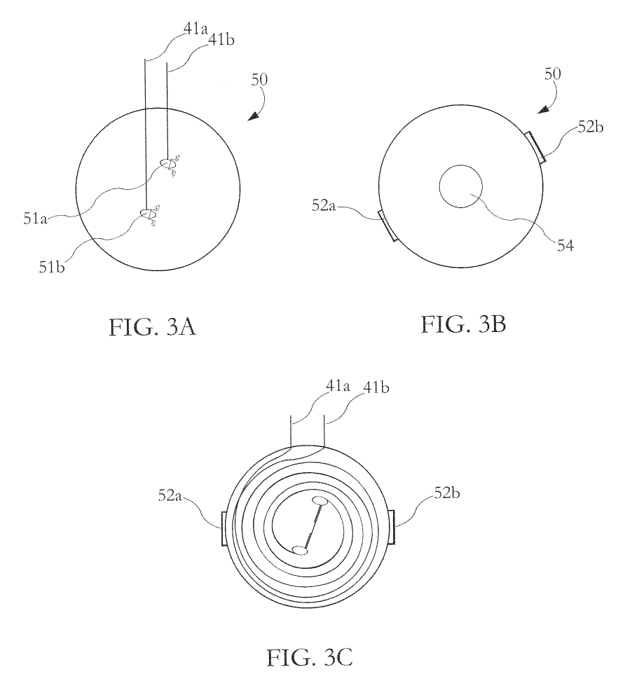

FIG. 2 illustrates a view of the device 100 configured on a window blind 40. In use, the device 100 is opened to assume the open position. In the open position of the device 100, the tassel is housed within the cavity configured between the first member 12 and the second member 14 of the housing 10. More specifically, the cords of the blind are passed through the apertures 26, 28 such that the tassel is housed within the cavity configured by the first member 10 and the second member 12. Once the tassel is housed within the cavity of the housing 10, the first member 12 and the second member 14 are brought closer to each other to assume the closed position. Thereafter the device 100 may be attached to the cords with the help of attachment means 30 at a safe distance above the reach of the infants and small children. In one exemplary embodiment of the present invention, the tassel is removed from the cords and the cords are inserted into the housing 10 through the apertures 26, 28 thereby precluding the need of the tassel.

It will be evident to a person skilled in the art that the present invention is not limited to the embodiment herein illustrated with reference to FIGS. 1 & 2, and as such many other embodiments of the present invention in terms of the configurations and functional features are possible without deviating from the scope of the present invention. Further, any such work will also fall under scope of the present invention.

The device 100 may be configured in a multitude of size and shapes. In an embodiment of the present invention, the device 100 may have a shape of crescent, sun, star, and the like.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

What is claimed is:

1. A cord safety device for a window blind comprising:
a. a housing, where said housing includes a first member and a second member, said first member and second member adjoined by a connecting member;
b. an attachment means mounted on the housing, where said attachment means provides a means to attach the device to cords used to adjust the configuration of the window blind; and
c. a cavity between the first member and second member, where said cavity stores the cords when the first member and second member are in a closed position.

2. The cord safety device according to claim 1, where said first member includes a first base portion with a first skirt extending from a periphery of the first base portion and the second member includes a second base portion with a second skirt extending from a periphery of the second base portion.

3. The cord safety device according to claim 2, where said first member and said second member are configured to assume at least one of a closed position and an open position.

4. The cord safety device according to claim 3, where in the closed position, the first member and the second member are arranged in a manner such that the first skirt abuts the second skirt to form the cavity in between the first member and the second member.

5. The cord safety device according to claim 2, where said first base portion includes at least one aperture, where said at least one aperture allows the cords to pass into the housing.

6. The cord safety device according to claim 1 where said attachment means includes at least one of a hooked shaped member and a clip that holds the device in place on the cords.

7. The cord safety device according to claim 1, where said attachment means places the device outside the reach of a child.
